(19) United States
(12) Patent Application Publication
(10) Pub. No.: US 2021/0034339 A1
(43) Pub. Date: Feb. 4, 2021

(54) SYSTEM AND METHOD FOR EMPLOYING CONSTRAINT BASED AUTHORING

(71) Applicant: Kleeen Software Inc., San Jose, CA (US)

(72) Inventors: Edison Romero, Tibas (CR); Sebastián Álvarez, Desamparados (CR); Mainor Gamboa, San Ramon, CA (US); Joshua Hailpern, San Jose, CA (US); Jorge Ramírez, Heredia (CR); Juan Carlos Valerio, Tibás (CR); Amy Yoshitsu, Berkeley, CA (US)

(21) Appl. No.: 16/712,920

(22) Filed: Dec. 12, 2019

Related U.S. Application Data
(63) Continuation-in-part of application No. 16/455,179, filed on Jun. 27, 2019.

(51) Int. Cl. G06F 8/38; G06F 8/20; G06F 8/35; G06Q 10/10; G06N 20/00; G06N 5/04; G06F 40/205; G06F 40/289

(52) U.S. Cl. CPC G06F 8/38; G06F 8/20; G06F 8/35; G06Q 10/101; G06F 40/289; G06N 20/00; G06N 5/04; G06F 40/205; G06Q 10/103

(57) ABSTRACT

A computer-implemented method is disclosed. The method includes operations of receiving user input, parsing the user input to extract keywords and the key phrases, categorizing at least a portion of the keywords and the key phrases, constructing a conceptual model based on at least a portion of the categorized keywords and the categorized key phrases, determining one or more constraints based on one or more of the user input or the conceptual model, and generating at least a first proposed user interface (UI) design using machine learning techniques, wherein the one or more constraints are provided as input to a trained machine learning model, wherein processing by the trained machine learning model generates at least the first proposed UI design. The method may include an additional operation of causing rendering of the first UI design on a display screen thereby enabling a user to visualize the first UI design.

### CROSS-REFERENCE TO RELATED APPLICATION

This application is a continuation-in-part of U.S. application Ser. No. 16/455,179, filed Jun. 27, 2019, the entire contents of both are incorporated herein by reference.

### FIELD

The technology described herein relates generally to software development. More particularly, the technology relates to constraint-based generation of computer software components that

### GENERAL BACKGROUND

Currently, most Enterprise Software-as-a-Service (SaaS) Products are not meeting end users' design expectations and usability needs, both of which have increased in recent times. Companies trying to solve this problem may not have the resources (time, talent, funds, etc.) to meet these goals, and the results are products whose core values and unique features may be hidden, uninspiring, difficult to access, or otherwise. The overall experience provided through many products' current User Interfaces (UIs) are neither enjoyable nor engaging. Design and development teams may be locked into ultimately unproductive cycles due to technical debt and trying to provide bandages instead of holistic solutions to problems.

Design teams may include User Experience (UX) designers who determine the processes by which an end user interacts with the UI to accomplish tasks and UI designers who determine the size, shapes, colors, and other graphical properties of the UI elements with which the end user interacts. Development teams include software engineers who write the computer software components that provide the UI and accomplish the UX tasks specified by the design team. A product manager is often present as well, specifying the business needs that a new feature or product must satisfy. Other input may come from back-end engineers and/or data scientists who convey both what the underlying computer system can accomplish and the data (and data format) currently stored. Traditionally, the back-end engineers or data scientists provide the initial information such that the UI and UX reflect the back-end architecture, rather than an end user-focused design based on collaboration between the multiple teams.

In-house and manual approaches to UI development may involve a chain of assumptions, personal biases, and miscommunications between teams. Often, a large or small product goal is driven by an individual or team who believes their goal may be achieved either by methods that are commonly used on the marketplace or methods driven by the creators' biases and unsubstantiated assumptions about end users. This may set the stage for a product whose proposed solutions will not adequately address the needs of end users.

This initial problem is often conveyed to the design team in the language of the assumed solution. Unfortunately, the design team (no matter the talent level) may not have the resources to complete a proper R&D phase in order to validate the assumptions driving the in-progress solutions. The solution mockups, often manually made by the designers, are therefore inevitably embedded with false assumptions. These solution mockups are then handed-off to the development team.

Not only is the interpretation of the design by the development team a challenge, it is often the case that the development team cannot implement the design within the timeframe required with the resources available. This leads to cycles of concept, design and development iterations that produce a product optimized for the teams' needs and resources, and not for the end users' experiences. Further compounding this problem are requirements by the product manager (usually informed by the back-end engineer), who changes goals or requirements too late in the production cycle, leading to major revisions.

One approach to producing interfaces is What You See Is What You Get (WYSIWYG) tools. WYSIWYG tools allow non-designers to create product interfaces. One advantage of the WYSIWYG approach is that the individual visual components are consistent in style and micro-behavior. A second advantage is that the visual components may be automatically converted into code.

The virtues of this approach are finite and limited when it comes to providing the best solutions for the end users' needs and problems. The creation of the whole interface and the UX is still dependent on the creator's knowledge of the end user and product sector, visual skill, usability knowledge, and knowledge of best practices in UI and UX design. As a result, the addition of WYSIWYG tools may not significantly improve productivity compared to the manual method and may even hinder the process since there are limited components available.

There are many potential disadvantages to using WYSIWYG tools. For example, the creator using the tools may falsely assume consistency is baked into the system, when actually it is dependent on the creator to use the components in a consistent and usable manner and to build usable tasks and patterns. Inconsistencies may also be introduced when there are multiple creators due to inadequate documentation or coordination, when creators wish to leave their mark on the product, and/or when creators engage and disengage with a project at different stages of development. WYSIWYG does not provide any guidance as to how to use a component for each unique requirement.

Furthermore, most WYSIWYG systems provide one component/solution per class of issues, and as a result, specific nuanced requirements and context cannot be addressed. Also, the code created by WYSIWYG may be a patchwork of non-scalable code snippets and may not be enterprise-grade. Finally, in most systems, a preview of the product depends on the creators having mid-to-high technical knowledge because the backend portion of the system needs to be manually connected to the code generated by the WYSIWYG tools.

Another approach is to use templates. Compared to the WYSIWYG approach, templates are even more limiting as they are made of larger, more rigid components. The creators are forced to select a template that is the “best fit” for a mid-to-large problem but does not actually provide a path towards the best solution. No longer is the issue that the system does not provide guidance for best practices and usability, but, instead, no matter how much knowledge a creating team has, templates cannot properly address the individual UI/UX needs of each product. And, like WYSIWYG, the resulting code is often neither scalable nor enterprise-grade.

As was referenced above, a significant disadvantage to human development of UIs or UXs is the unintended influence of the designers' human biases. For instance, a designer may have a tendency to utilize certain UI elements over others regardless of the situation, which may not be in accordance with best practices. Additionally, a designer can only develop a limited scope of possible UI designs in a given time frame. Further, when a designer is faced with a choice, the designer inherently has to weigh several options, the weighting of which is drastically influenced by human biases. What is needed is an automated system that, inter alia, removes the influence of human biases from the UI or UX design process and instead considers best practices as well as UI/UX design trends and real-world data (e.g., experiential data from collected from human use of previous UI/UX designs). Therefore, a need exists for a process that produces enterprise-grade user interfaces that provide a good user experience, and that does so more quickly, with fewer resources, and in a manner that is scalable.

### BRIEF DESCRIPTION OF THE DRAWINGS

Embodiments of the disclosure are illustrated by way of example and not by way of limitation in the figures of the accompanying drawings, in which like references indicate similar elements and in which:

FIG. 1 illustrates an end product produced according to some embodiments;

FIG. 2 illustrates a constraint-based software authoring system according to some embodiments;

FIG. 3 illustrates a constraint-based software authoring process according to some embodiments;

FIG. 4 is a logical representation of a second embodiment of a constraint-based software authoring system according to some embodiments;

FIG. 5 is a sample graphical user interface illustrating the costs of a department within a corporation compared to revenue for the same department according to some embodiments;

FIG. 6 illustrates a flowchart of a first exemplary method for generating a conceptual model by the authoring system 400 of FIG. 4 according to some embodiments;

FIG. 7 is an illustration of a sample detailed conceptual model in accordance with some embodiments; and

FIGS. 8A-8B illustrate a flowchart of a second exemplary method for generating a conceptual model by the authoring system 400 of FIG. 4 according to some embodiments.

### DETAILED DESCRIPTION

### I. General Overview

Embodiments relate to software development. In particular, embodiments relate to tools that automate portions of the production of User Interface (UI) design, code, or both, including designs and/or code related to navigation, theming, search, and internationalization, by producing design files and/or code based on creator-supplied input such as end-user goals, data constraints, and selections among available options. Based on these inputs, the technology produces theoretically-grounded UI recommendations and full or partial implementations.

In embodiments, a constraint-based software authoring system (herein after, the authoring system) interacts with a creating user (a user of the authoring system) to develop a set of constraints regarding an end product to be created by the authoring system.

The constraints may include properties of conceptual objects that are pertinent to the end product (such conceptual objects including, for example, a person, product, context component, abstract concept, and so on). The constraints on the conceptual objects may be used to select data types that represent the objects.

The constraints may also include properties of goals of end users of a task of the end product. These goals may include an expected class of outputs and constraints on how the outputs of the end product are presented.

From the constraints, the authoring system may determine a plurality of candidate workflows, navigation, theming, etc. (each corresponding to one or more tasks) by which the end user may accomplish their goals, and may rate the candidate workflows according to criteria related to the usability of the workflow. The criteria may take into account, for example, level of consistency, potential cognitive load required, and the like. The creating user may then select a workflow solution design (from a set of candidate workflow solution designs) for inclusion in the end product, and may use the ratings of the candidate solutions when doing so. These solutions can be tried or demoed by interacting with a production-code version of the design, on demand.

From the constraints, the authoring system may determine a plurality of candidate UI styles, and may rate the candidate UI styles (including palettes, flavors, etcetera) according to various usability criteria. The criteria may be based on, for example, level of consistency, potential cognitive load required, uniqueness in a field/discipline, and the like. The criteria may take into account, for example, suitability to a particular group of end users, such as suitability according to an age, a level of education, or specific knowledge of the end user. The UI styles may also be rated according to their suitability to selected workflows. The creating user may then select one or more UI styles for use in the end product, and may do so using the ratings for the candidate UI styles.

From the plurality of choices provided by the system, workflows, navigation, UI styles or other elements of a product's creation are selected by the creating user are used by the authoring system to generate computer programs and/or mockups for a user interface.

By this process, the authoring system may allow a creating user who is not skilled in the creation of UI design, UX workflow creation, or programming but has a good understanding of the end user, the problems faced by the end user, and/or the goals of the end user to create a good UI for accomplishing the goals of the end user. Furthermore, the authoring tool may provide suggestions that even a skilled UI creator might have overlooked (due to their own personal experience, education, the latest research on best practices, etc.), and may help to educate the creating user in the best practices of User Experience (UX) design. It should be well understood that each embodiment of the authoring system described herein provides a distinct technological improvement in the field of UI and UX design. Specifically, the authoring system automates the process and enables a creating user to see optionally a plurality of proposed UI/UX designs within a short time period (e.g., 10 seconds to 10 minutes, possibly depending on available computing resources). In addition, the authoring system also provides a systematic method for maintaining and accounting for all constraints and all user input without biases during the UI and UX design generation process. Thus, while a creating user does not have the mental capacity or otherwise the ability to maintain and consider all user input, determine (and in certain instances develop) all possible and/or desired constraints on the UI and UX designs, the authoring system provides such a possibility.

Continuing the discussion of technological improvements provided by the authoring system, the automated nature of the authoring system provides a creating user to not only develop a plurality of UI and UX designs but also test demos of the proposed UI and UX designs proposed by the authoring system. For example, a proposed UI design may include test data (or data provided by the creating user) that enables the UI elements to function in a manner similar to that of production ready code (e.g., display data on a graph within a widget, provide sample text within drop-downs or other UI elements). Thus, by providing a demo, the authoring system generates some software code that includes provides a graphical display of the proposed UI design but also provides at least some access to functionality of the UI design. In one embodiment, in order to accomplish the task of providing a demo UI design, the authoring system automatically generates various files and documents, and my establish links to certain data stores, repositories and/or libraries.

In embodiments, the authoring system may focus on the production of computer programs that provide necessary and ubiquitous aspects of a certain class of software products (for example, Software-as-a-Service products). Such aspects may include infrastructure (navigation, theming—style and components) and archetypes (configuration—editing details of data and information; dashboards—pages and tasks that display information; investigations—pages and tasks that allow end users to find and solve a problem, etc.).

In the following detailed description, certain illustrative embodiments have been illustrated and described. As those skilled in the art would realize, these embodiments are capable of modification in various different ways without departing from the scope of the present disclosure. Accordingly, the drawings and description are to be regarded as illustrative in nature and not restrictive. Like reference numerals designate like elements in the specification.

Embodiments relate to the generation of UIs that provide a UX. The lowest (simplest) elements of the UI may be termed atoms (e.g., form fields, buttons, visualization, or text). Atoms may be combined with properties, logic, and functionality to form molecules (e.g., a search box, check-box list, or menu). Molecules may be combined to create an organism corresponding to a relatively complex, distinct section of the UI (e.g., a navigation header, filter panel, or gallery layout). Multiple organisms may be combined to resolve a task corresponding to an archetypal flow of an end user (e.g., performing monitoring, triage, configuration, or editing). The UI may be composed of one or more pages each corresponding to an instance of a task and using specific organisms with specific data (e.g., a product's portal or dashboard).

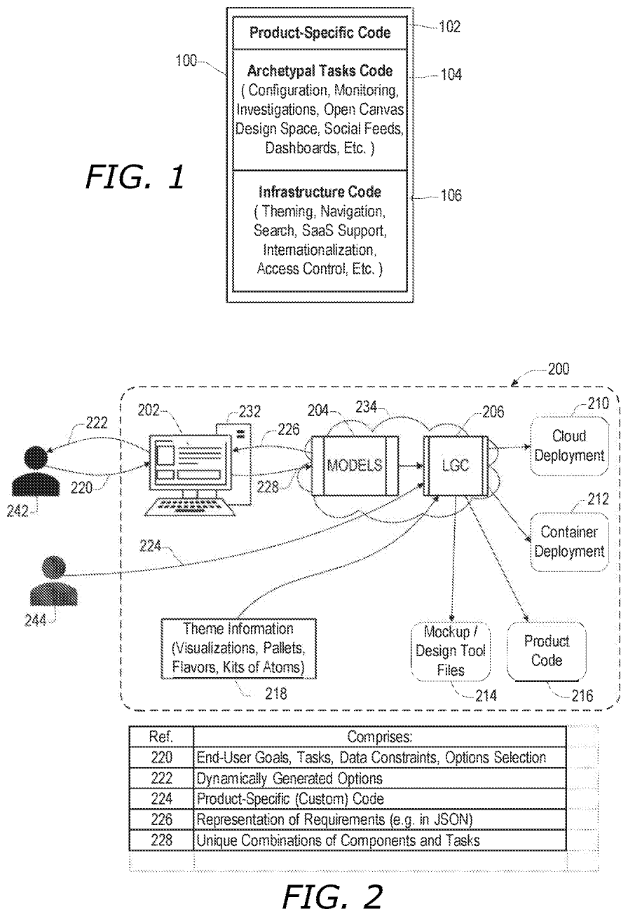

FIG. 1 illustrates an end product 100 produced according to an embodiment. The end product 100 includes Archetypal Tasks Code 104 that may provide the end user with workflows or tasks for Configuration, Monitoring, Investigations, Open Canvas Design Space (e.g. for data visualization), Social Feeds, Dashboards, and the like. The end product 100 may further include Infrastructure Code 106 for performing Theming, Navigation, Search, SaaS Support, Internationalization, Access Control, and the like. The end product 100 may also include product-specific components 102 for performing functions that may be specific or unique to the end product 100.

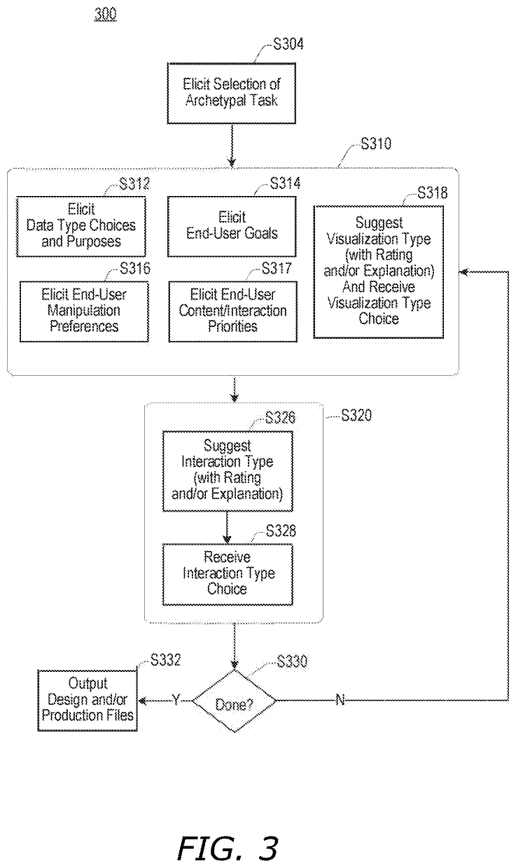

FIG. 2 illustrates a constraint-based software authoring system 200 according to an embodiment. In the embodiment of FIG. 2, the authoring system 200 includes a picker 202 being provided using a workstation computer 232, and a modeling system 204 and logic conversion system 206 being provided using a cloud server 234, but embodiments are not limited thereto. The authoring system 200 may be used to produce a User Interface for an end product such as the end product 100 of FIG. 1.

The picker 202 interacts with a creating user 242. The picker 202 provides prompts to and receives inputs 220 from the creating user 242. The inputs 220 may include end user goals, data constraints, and selections from options presented by the picker 202 to the creating user 242. The inputs may include selections from a menu or natural language input.

Illustrative end user goals may include identifying outliers in a dataset, comparing and contrasting different portions of a dataset, being able to browse all the points in the dataset, detecting general trends in a dataset, and the like. An end user may have multiple such goals for the end product.

In an embodiment, inputs received by the picker 202 from the creating user 242 may include indication of one or more types of tasks the end product will support and that are best for the end user. Example types of tasks include dashboards, profiles, news/social feeds, investigations, and so on. Determining these tasks may be the initial step in using the authoring system 200. The authoring system 200 may then guide the creating user 242 through all the implications of these task choices and capture constraints so that the creating user 242 can choose the best layout and UX options within an Archetype solution.

In an embodiment, inputs received by the picker 202 from the creating user 242 may include information on one or more objects, relationships between the objects, and actions that may be performed on the object. When any creating team is conceptualizing a new end product or augmenting an existing end product, the Objects and the end users' goals may drive the design. The end users' goals imply a task or operation and the combination of Objects and Operations are the conceptual elements of a Task. This may be known as an object-first approach.

The authoring system 200 may determine types of tasks that make up the end product according to constraints at the Object/Operation level and by the holistic goals and habits of the End User.

The picker 202 may process the inputs 220 using any or all of pre-coded decision trees, artificial intelligence, machine learning, probabilistic modelling, or rule mining to analyze the inputs 220. Based on this analysis, the picker 202 may elicit additional information from the creating user 242.

For example, if the creating user 242 indicates that the end product is an e-commerce site, the picker 202 may present the creating user 242 with questions related to e-commerce sites or to make selections from among options related to e-commerce sites. If the creating user 242 indicates that the end product is a “medical records” app, the authoring system 200 may select appropriate objects and tasks (in an embodiment, subject to the creating user's confirmation of the choices made by authoring system 200) and may also add, for example, navigation-related constraints as discussed below.

The picker 202 may use each new input from the creating user 242 to determine additional queries. An end user having a particular constraint may limit the set of options that the creating user 242 is allowed to select from.

The picker 202 may also solicit the creating user 242 to pick a Flavor for the User Interface. A Flavor may include a collection of shapes, fonts, animations, and the like that give a user interface a distinctive feel and that may include or be combined with a palette of colors. Some examples of possible Flavors include Futuristic, Minimal, Corporate, etc. Each choice provides additional non-semantic styling to all UI Components such that the look and feel of the end product can align with the creating user's branding message and easily situate an end product in a mental category of the end user.

The picker 202 may also solicit information from the creating user 242 about any product-specific components 224 that will be incorporated into the end product. The product-specific components 224 may include custom pages, custom workflows, custom functional codes, or combinations thereof. The authoring system 200 then creates a skeleton (that is, an interface specification akin to a “.h” file in the C programming language or an abstract class in Java) to allow that authoring system to incorporate the product-specific components 224 into the output of the authoring system 200.

The picker 202 may also receive navigation-related constraints from the creating user 242. Navigational constraints can include notification requirements for events, confirmation requirements for commands, the number of accounts one end user can access in the interface at a time, and so on. The picker 202 may also elicit from the creating user 242 information about the importance and desired prominence of each Task in the end product (and the associated data types and goals).

In response to the received navigation-related constraints, the importance and desired prominence of each task, and the other constraints provided by the creative user 242, the picker 202 may determine one or more suggested navigation approaches and present the suggestions to the creative user 242. The creative user 242 may then indicate a selected navigation approach or approaches to the picker 202. Based on the received navigation-related constraints, the suggested navigation approaches may include specific high-level functionality, such as a notification alert button or an account picker.

Based on the one or more selected navigation approaches, the navigation-related constraints, the pages created, and/or the actual content of the pages, the authoring system 200 creates a navigation infrastructure including layouts and methods.

Based on the inputs 222, the picker 202 communicates a representation of requirements 226 for the end product to the modeling system 204. The representation of the requirements may be, for example, in JavaScript Object Notation (JSON).

The modeling system 204 includes one or more predictive models that, based on the representation of requirements 226, produce a plurality of options 208. Each option may be a unique combination of components and workflows, and each may be given a score indicates the usability of that option. The usability may be determined by each combination's level of consistency, potential cognitive load required, and so on.

In an embodiment, each organism may have PROS, CONS and REJECTION information that may be used to determine the usability score. For example, a certain filter design (e.g. amazon's check boxes on the left side) may be optimal for certain situations indicated in the filter's PROS information, may have some draw backs for certain situations indicated in its CONS information, and may be inappropriate (and therefore should never be used) for situations indicated in its REJECTION information. To satisfy any given user need (such as filtering) the authoring system 200 may have many organisms in a “class” that are available to satisfy that need, and every TASK will have many “classes” of organisms where one of each is needed. The authoring system may evaluate through every permutation (not combination) of one from every class and determine the aggregate usability score. Some permutations may be rejected because one or more of the organisms therein violate a user's goal for the task (e.g. user input) as indicated by that goal being in the REJECTION information of the one or more of the organisms. Then a usability score for each permutation may the determined by, for example, adding ‘1’ whenever a current situation is indicated in the PROS information of an organism of the permutation and subtracting 1 whenever a current situation is indicated in the CONS information of an organism of the permutation.

Each option may be accompanied by not only a usability score, but also an explanation of which end user needs that option may address, why that option might be the most responsive way to address the end user's needs, or both.

The modeling system 204 communicates the plurality of options to the picker 202. The picker 202 may then present the options with their usability scores and explanations, if present, to the creating user 242. The picker 202 may then solicit a selection of one or more of the options. In some cases, the selection of one of the options may result in the picker 202 soliciting more information from the creating user 242 in order to further refine the constraints.

Once the above process is complete, the selected combination of components and workflows, along with information and constraints from the picker 202, are provided to the logic conversion system 206. The logic conversion system 206 may use these components, workflows, constraints and other information, along with along with product-specific components 224 if present, to produce one or more mockups/design tool files 214 representing the user interface of the end product.

The logic conversion system 206 may also use palettes, flavors, kits, and visualizations from one or more theme information sources 218 to create the one or more mockups/design tool files 214. The theme information files 218 may include information defining graphic elements, code to perform actions (such as drawing, activating, and deactivating) associated with the graphic elements, parameters to use when performing those actions, or combinations thereof. Theme information files may be selected by the creating user 242.

Palettes in the theme information files 218 take in constraints of brand colors and the importance of colors, and generate groups of colors (primary, secondary, neutral, supporting, etcetera) where the importance of the color is valued, and does not have a semantic use in the product produced by the authoring system 200. The creating user 242 is therefore free to choose a palette according to their own criteria.

Flavors in the theme information files 218 take in stylistic goals (e.g. flat, modem, futuristic, corporate) and include information used to generate styling of a product (e.g. drop shadows, glows). Flavors may also specify how to use one or more of the palette colors (e.g. applying a semantic use case like “hover color” or “link color” to a specific palette color).

Visualizations in the theme information files 218 follow a similar logic and correspond to classes of ways to style and design visualizations. For example, there are many ways to design a bar chart, a pie chart, or a scatter chart, and a theme may include respective visualization for each such chart, all with a common stylistic feelings that may be specific to that theme.

Kits in the theme information files 218 are comprised of low level atoms (the basic unit of UI, such as a form field, or a button), and define the way those atoms look and function in the theme, i.e., a “design language.” In each kit, all the atoms follow the same design language. The atoms in kits may also include shared logic. The shared logic of a selected kit may be imparted into every other selected kits. For example, a kit may include logic for a user tracking feature that would then by inherited by all the other kits. The shared logic may reference internal code that is not public.

Theme information files 218 may also include visualization kits, wherein in each visualization kit, a plurality of visualizations share a design language (e.g., a flat design language, a 3D design language, and so on.) Each visualization may be treated like an atom by the creating user. Like the kits of atoms, kits of visualizations may include shared logic. Visualization kits may inherit shared logic from atom kits, and vice versa. The shared logic may reference internal code that is not public.

Kits may also be sandboxed for security. This prevents the author of a kit from intentionally or unintentionally creating a security vulnerability in the product.

Kits can be baked into a product. They can be created to be completely internal to a customer, or may be shared or licensed via a marketplace.

The logic conversion system 206 uses on the atoms to generate many elements of the mockups/design tool files 214. Atoms are abstract representations of the UI element they represent. In embodiments, an atom exports itself into the mockup/design tool files 214 as an image (e.g., Portable Network Graphics (PNG), Joint Picture Expert Group (JPEG), or Scalable Vector Graphic (SVG), etc.), as code (e.g., React, Angular, Vue.js, etc.), or as combinations thereof, and the authoring system 200 provides the higher level logic. The code and images are to a large extent automatically correct as they are a product of the atoms exporting themselves, and take in the palette, flavors, etc.

The mockup/design tool files 214 may include one or more high-quality mockups (in, for example, PNG, JPEG, or SVG format), one or more editable design tool files (for example, Sketch or Adobe Illustrator® files), or both. The mockup/design tool files 214 are based on design decisions, components, pages, etc., and may be used for internal design, future work, etc. They may be produced based on the selections of the creating user 242 regarding preferred UI component system types, colors, fonts, flavors (described above), non-semantic styling preferences, and the anticipated sizes of screens on which the end user will view the end product. Further development of the end product may be commenced based on the sketch files 214.

In embodiments, the authoring system 200 may also produce pixel-accurate mockups of the end product, including every screen of every page and task, using the UI components expressed in the mockup/design tool files 214. The creating user 242 may have access to all the UI components (and, in embodiments, the corresponding scalable code) expressed in the mockup/design tool files 214, and may use them when generating custom pages so that consistency may be maintained between the portions of the end product produced by the authoring system 200 and the portions custom-created by the creating user 242 or designer 244.

The logic conversion system 206 may also use the components, workflows, constraints and other information along with (optionally) product-specific components 224 to produce finished end product software, such as stand-alone product code 216, a container deployment 212 (i.e., a package of code, configurations, and dependencies), and/or a cloud deployment 210 (such as for Amazon Web Services (AWS), Google Cloud, Microsoft Azure, or the like). The designer 244 of the product-specific components 224 may be the same person or team as the creating user 242, or may be a different person or team. The product-specific components 224 may be developed using a Software Development Kit (SDK) associated with the authoring system 200.

Any one of the mockup/design tool files 214, stand-alone product code 216, container deployment 212, cloud deployment 210, or combinations thereof may correspond to the end product.

The outputs of the logic conversion system 206 may be created from carefully crafted libraries produced by the analysis of UIs that provide good UX, and specifically on analysis that focuses on the uses and meanings of layout, styling, and micro-behavior per component type. Accordingly, a UI produced using the authoring system 200 may intentionally use a specifically-styled button for a specific situation and context, for example, when an end user is faced with a choice in a specific context, such as an action being primary but in the disabled state. Pairing an intentionally-styled component to the same state or function in all use cases yields high consistency and usability. Additionally, populating end products with components derived from the analysis of widely-established systems results in the end product having usage patterns and interactions that are already familiar to many end users, thus decreasing the potential learning curve and increasing the usability of the end product.

By using the constraint-based authoring system 200, the creating user 242 may produce a design and enterprise-grade code based on the creating user's knowledge. While the specific information of each end product is unique to the data it features, that information is finite. Accordingly, constraint-based authoring system 200 may unburden creators from spending unnecessary time and energy attempting to reinvent solutions to common or predictable end product requirements, provide a known-best-practices solution to the requirements, and allow creators to spend more time and focus creativity on the high-value and unique features of their end product, such as may be provided via the product-specific components 224.

The authoring system 200 serves to decrease the time and effort placed into the development of “standard” aspects of an end product, and therefore increase the opportunity for creating users' talents to highlight the value proposition of the end product. A creating user is allowed and encouraged to include custom pages and tasks and custom areas within the pages/tasks into the end product. Additionally, by allowing the creating user to access UI components (and their code) that may be usable for the custom functionality, the authoring system 200 may make once-tedious aspects of design and development more efficient, thereby providing more resources for creative opportunities and envelope-pushing. The authoring system 200 can connect the end user's web, social, and product interactions into one seamless experience.

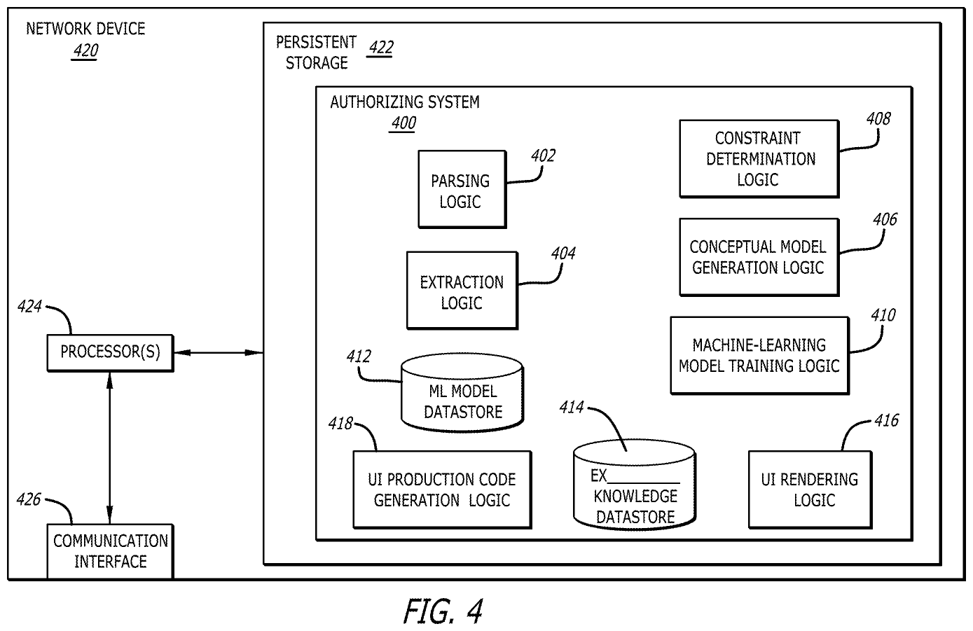

FIG. 3 illustrates a process 300 for performing constraint-based software authoring, and in particular for constraint-based authoring of a task, according to an embodiment. The process 300 may be performed by one or more of the computer 232 and/or cloud server(s) 234 shown in FIG. 2 and may produce an end product such as the end product 100 shown in FIG. 1.

A first phase S304 of the process 300 elicits selection of an archetypal task. For example, the archetypal task may be elicited using a list of available archetypal tasks, or using a natural language query, but embodiments are not limited thereto.

A second phase S310 of the process 300 solicits, based on the selected archetypal task, constraints and other information regarding the end product and the end user who will use the end product. Elements of the first phase S310 may be performed in any order, and may be performed repeatedly. Each element of the first phase S310 may be performed zero or more times. The elicitations performed in the first phase S310 may be performed using spoken or written natural language, selection from a list of available or suggested options, and the like. Each elicitation may be performed according to previous information provided to the process 300.

At S312, the process 300 elicits data type choices from a creating user, and may do so in light of previous information provided to the process 300. For example, a list of available data types may be tailored to an application type or archetypal task previously selected by the creating user. At S312, the process 300 may also elicit the purpose of the data being represented by the data type, that is, why the user is interested in the data. For example, the task being authored may seek to identify outliers of the data represented by the data type.

At S314, the process 300 elicits end user goals from the creating user. The end user goals may be at a very high level (e.g. “manage medical records,” “conduct e-commerce”) or more specific (e.g., “identify outliers in datasets,” “identify trends”).

At S316, the process 300 elicits end user manipulation preferences. Manipulation preferences may include general preferences (e.g. graphical manipulation versus text editing) or specific manipulation paradigms the end user prefers (e.g., check boxes, radio buttons, sliders, spinners, interactive canvases, etcetera). Embodiments may allow manipulation preferences to be specified generally according to a data type, a purpose of data, or combinations thereof.

At S317, the process 300 elicits end user content/interaction priorities from the creating user, in accordance with, for example, which data or interactions the end user will consider most important, perform most often, input or modify most often, and the like.

At S318, the process 300 may optionally suggest one or more visualization types to the creating user. Each suggested visualization type may be accompanied by a usability rating, an explanation of why it may be appropriate to the end product being authored, or both. Visualization types may include graphs, maps, tables, and the like, including specific types of visualization tailored to the constraints (such as data types, data purposes, goals, and manipulation preferences) previously received by the process 300. Suggested visualizations may include dials, gages, heat maps, line graphs, bar graphs, timelines, etcetera, or combinations thereof).

The process 300 may then receive at least one choice of visualization type selected from one or more visualization types by the creating user. In an embodiment, the creating user may decline to choose any of the suggested one or more visualization types. The information that the creating user found all of the suggested one or more visualization types unacceptable may be used by the process 300 to determine and present additional suggested visualization types different from those previously presented.

A third phase S320 of the process 300 may follow the first phase 310 and may be based upon the information previously acquired by the process 300.

At S326, the process 300 suggests one or more holistic interaction types to the creating user. Each suggested holistic interaction type may be accompanied by a usability rating (e.g., a usability score), an explanation of why it may be appropriate to the end product being authored, or both.

At S328, the process 300 receives at least one choice of interaction type selected from one or more visualization types by the creating user. In an embodiment, the creating user may decline to choose any of the one or more suggested holistic interaction types. The information that the creating user found all of the suggested one or more interaction types unacceptable may be used by the process 300 to determine and present additional suggested interaction types different from those previously presented. The process 300 may repeatedly perform S326 and S328.

At S330, the process 300 determines whether the creating user is finished with providing constraints and other information to the process 300. If the creating user is done, then at S330 the process 300 proceeds to S332; otherwise at S330 the process 300 may proceed to S310 to acquire additional information from the creating user.

At S332 the process 300 outputs one or more sets of design files, production files, or combinations thereof, according to the information collected at earlier stages of the process 300. The design files may include a Sketch file, a Portable Document Format (PDF) file, a Word document, a PowerPoint document, or the like. The production files may include product code (e.g., computer programs in C, C++, Java, Python, JavaScript, or the like), a container deployment, a cloud deployment, or combinations thereof.

Embodiments of the present disclosure include electronic devices configured to perform one or more of the operations described herein. However, embodiments are not limited thereto. Embodiments of the present disclosure may further include systems configured to operate using the processes described herein.

Embodiments of the present disclosure may be implemented in the form of program instructions executable through various computer means, such as a processor or microcontroller, and recorded in a non-transitory computer-readable medium. The non-transitory computer-readable medium may include one or more of program instructions, data files, data structures, and so on. The program instructions may be adapted to execute the processes described herein.

In an embodiment, the non-transitory computer-readable medium may include a read only memory (ROM), a random access memory (RAM), or a flash memory. In an embodiment, the non-transitory computer-readable medium may include a magnetic, optical, or magneto-optical disc such as a hard disk drive, a floppy disc, a CD-ROM, and the like.

In some cases, an embodiment of the invention may be an apparatus that includes one or more hardware and software logic structure for performing one or more of the operations described herein. For example, as described above, the apparatus may include a memory unit, which stores instructions that may be executed by a hardware processor installed in the apparatus. The apparatus may also include one or more other hardware or software elements, including a network interface, a display device, etc.

### II. General Architecture

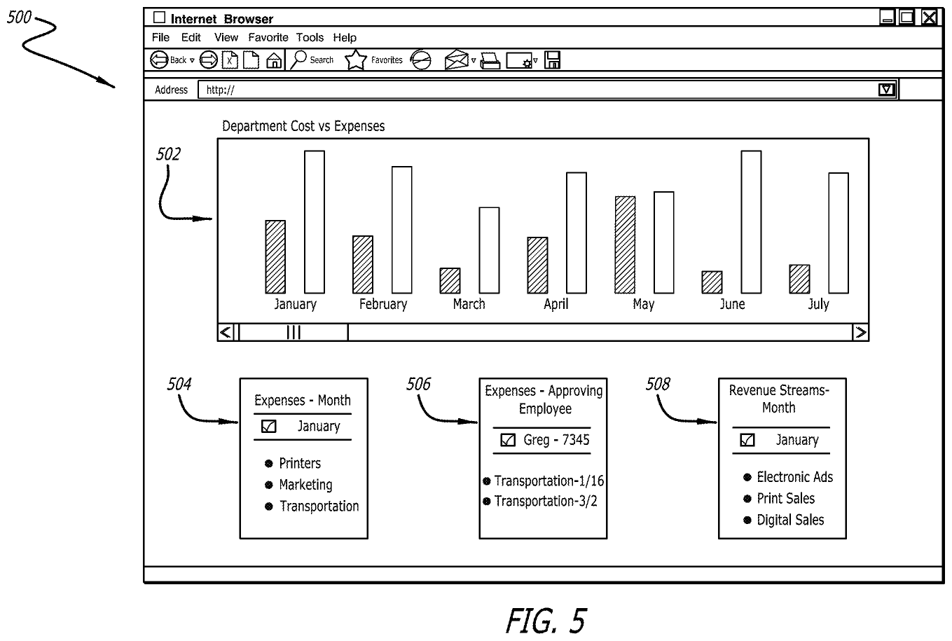

Embodiments of the general architecture disclosed herein relate to a system configured to automatically generate a plurality of UI designs that may be automatically converted into software code for deployment with a web site, mobile application or user-facing graphical display. The system discussed below may refer to a second embodiment of a constraint-based software authoring system (“authoring system”). The second embodiment of the authoring system is illustrated as the authoring system 400 in FIG. 4 below. Additionally, various methods will be disclosed including operations performed by the authoring system 400 associated with the automated generation of the plurality of UI designs. In particular, the authoring system 400 comprises logic that is executable by one or more processors to perform the operations as discussed. Each of the terms “logic” and “component” (which may be used interchangeably herein) may be representative of hardware, firmware or software that is configured to perform one or more functions. As hardware, the term logic (or component) may include circuitry having data processing and/or storage functionality. Examples of such circuitry may include, but are not limited or restricted to a hardware processor (e.g., microprocessor, one or more processor cores, a digital signal processor, a programmable gate array, a microcontroller, an application specific integrated circuit “ASIC”, etc.), a semiconductor memory, or combinatorial elements.

Additionally, or in the alternative, the logic (or component) may include software such as one or more processes, one or more instances, Application Programming Interface(s) (API), subroutine(s), function(s), applet(s), servlet(s), routine(s), source code, object code, shared library/dynamic link library (dll), or even one or more instructions. This software may be stored in any type of a suitable non-transitory storage medium, or transitory storage medium (e.g., electrical, optical, acoustical or other form of propagated signals such as carrier waves, infrared signals, or digital signals). Examples of a non-transitory storage medium may include, but are not limited or restricted to a programmable circuit; non-persistent storage such as volatile memory (e.g., any type of random access memory “RAM”); or persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the logic (or component) may be stored in persistent storage.

The following paragraphs provide general definitions for certain terminology used herein. For example, term “computerized” generally represents that any corresponding operations are conducted by hardware in combination with software and/or firmware. The term “data store” generally refers to a data storage device such as the non-transitory storage medium described above, which may include a repository for non-persistent or persistent storage of collected data.

Finally, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Embodiments relate to a logic-based authoring system 400 that receives user input corresponding to needs or desires of the user for a user interface. The authoring system 400 determines a set of entities, one or more attributes for each entity and one or more relationships (between entities), if applicable, from the user input and generates a conceptual model based on the set of entities and the one or more attributes for each entity. Herein, a “conceptual model” is generally an automatically generated, computerized representation of the entities and attributes as described in user input as received by the authoring system 400. In one embodiment, the conceptual model may be a heterogeneous information network (HIN) representing each entity, corresponding attributes and relationships between entities. The conceptual model captures semantic meaning in a computerized representation. In one embodiment, the conceptual model may be HIN taking the form of a nodal diagram, wherein each entity is a node and a relationship is an edge. Further, attributes of each entity may be linked to the corresponding entity illustrated the figures provided herein and will be described in more detail below.

Based on user input expressing the “product goals” they wish to supply to their end users (e.g. the conceptual model, target end-user persona information, and task/end-user goal specific context—what the end user needs to do, why the need to do it, and what information/steps thy must achieve along the way), the authoring system 400 may determine constraints to be provided to a trained machine learning (ML) model that affect, limit, or influence the decisions of the trained ML model when generating a decision (also referred to as an outcome). The constraints may include a computerized representation of conditions or patterns extracted from the conceptual model. Additionally, one or more constraints may also be derived directly from user input that corresponds to tasks, directives, objectives as well as theming, navigation, end-user management, etc., as described in the user input. For example, the user input may explicitly provide the authoring system 400 with certain constraints such as a particular type of information to display, particular behavior for filtering/manipulating data, ways of interacting with the visual medium, actions a user may need to perform, results of a particular calculation to display, etc.

In some embodiments, the ML model may provide a plurality of UI designs that each satisfy the constraints provided as input to the ML model (“proposed UI designs”). Additionally, each UI design may be associated with a ranking score(s) score representing some aspects of quality based on the ML model that the UI design is the best possible UI design along some metric (e.g. usability, consistency, intuitiveness, complexity, accessibility, general confidence of overall quality, etc.). These metrics may be strongly based on (but not limited to) the confidence of the model, on some set of simulated interactions, or an evaluation comparing the generated design against the requested behavior specified by the user.

The authoring system 400 may be further configured to receive additional user input (“feedback”) corresponding to selection of a proposed UI design, and a request for additional proposed UI designs similar to a particular proposed UI design, or a rejection of the proposed UI designs. When the additional user input is a request for additional proposed UI designs or a rejection of the proposed UI designs, the feedback may be utilized by the authoring system 400 to adjust or modify the constraints provided to the trained ML model such that a modified set of constraints is provided as input to the trained ML model so that a second set of proposed UI designs may be generated and presented to the user. It should be noted that in some embodiments, the trained ML model may provide a single proposed UI design that satisfies the constraints provided as input to the trained ML model.

Various ML models may be employed by the authoring system 400 either independently, in parallel (to gather multiple outputs), or in an ensemble learning approach (where the models influence each other and jointly produce one weighted/ranked outcome). For instance, the ML model training logic 410 may train a ruled-based ML model.

The UI designs presented to the user (“proposed UI designs”) may include logic, such as design code related to navigation, theming, search, and internationalization. In some embodiments, the UI designs may refer to production-ready logic. In other embodiments, the UI designs may refer to logic representing a mock-up of the UI such that a demo of the UI may be rendered on a display screen for previewing by the user. For instance, the proposed UI designs include more than the appearance of the interface but also illustrate how various components interact, a diagram of the full user workflow and interconnections between UI components or pages (similar to a site map), how various filters may be applied, and generally how user input affects the content displayed by the proposed UI design. In other embodiments, the proposed UI designs may refer to component libraries.

As used herein, the term “constraints” may refer to input to be provided to a ML model that affect, limit, or influence the decisions of the ML model when generating a decision (also referred to as an outcome). The constraints may include a computerized representation of (i) conditions or patterns extracted from a conceptual model, (ii) tasks, directives, objectives as well as theming, navigation, end-user management, etc., as described in the user input.

Multiple embodiments are disclosed in the following description; however, only certain illustrative embodiments have been illustrated and described. As those skilled in the art would realize, these embodiments are capable of modification in various different ways without departing from the scope of the present disclosure. Accordingly, the drawings and description are to be regarded as illustrative in nature and not restrictive. Like reference numerals designate like elements in the specification.

Specifically, current methods for generating UI designs do not involve the generation of a conceptual model as described herein. The authoring system 400 includes various logic components that receive user input, generate a conceptual model based on the entities, attributes and relationships described in the user input, and determine constraints based on the user input, product context (e.g. navigation, other pages, etc.), existing end-user behavioral data and the conceptual model. Further, the authoring system 400 provides the constraints as input to a ML model, which performs operations that map the user input to UI elements and provide proposed UI designs in accordance with the user input. As one example, a portion of the received user input may correspond to business requirements for a particular UI. For instance, a business requirement may be that the desired UI have a dashboard, which includes a plurality of widgets, wherein each widget displays information such as expenses over time, expenses compared to revenue on a monthly basis, expenses per employee, etc. Further, the business requirements may include the ability to “drill down” or, based on user input, obtain additional information possibly through a second display window, a pop-up or otherwise. Another business requirement may be that any employee name may be selected to display attributes of the employee (e.g., name, employee ID, salary, etc.). Additional user input may include a description of particular entities, attributes for one or more entities and corresponding relationships. Based on the description of the entities, attributes and relationships, the authoring system 400 builds a conceptual model. Based on the business requirements and the conceptual model, the authoring system 400 determines a set of constraints to provide to a machine-learning model, which upon processing the constraints determines one or more proposed UI designs in accordance with the training of the machine-learning model.

The generation of a conceptual model setting forth a computerized representation of the description of the entities, attributes and relationships to be displayed in the desired UI design is unique to the authoring system described herein.

Referring to FIG. 4, a logical representation of a second embodiment of a constraint-based software authoring system is shown according to some embodiments. The constraint-based software authoring system (authoring system) 400, in an embodiment, may be stored on a non-transitory computer-readable storage medium 422 (“persistent storage”) of a network device 420 that includes a housing, which may be made entirely or partially of a hardened material (e.g., hardened plastic, metal, glass, composite or any combination thereof) that protects the circuitry within the housing, namely one or more processors 424 that are coupled to a communication interface 426. The communication interface 426, in combination with a communication logic (not shown), enables communications with external network devices and/or other network appliances, i.e., enabling the receipt of user input by the authoring system 400. According to one embodiment of the disclosure, the communication interface 426 may be implemented as a physical interface including one or more ports for wired connectors. Additionally, or in the alternative, the communication interface 426 may be implemented with one or more radio units for supporting wireless communications with other electronic devices. The communication interface logic may include logic for performing operations of receiving and transmitting one or more objects via the communication interface 426 to enable communication between the authoring system 400 and network devices via a network (e.g., the internet) and/or cloud computing services, not shown.

The processor(s) 424 is further coupled to the persistent storage 422 and may include the following logic as software modules: a parsing logic 402, an extraction logic 404, a conceptual model generation logic 406, a constraint determination logic 408, a machine learning model training logic 410, a machine learning model data store 412, an experiential knowledge data store 414, a user interface (UI) rendering logic 416 and a UI production code generation logic 418. The operations of these software modules, upon execution by the processor(s) 424, are described below. Of course, it is contemplated that some or all of this logic may be implemented as hardware, and if so, such logic could be implemented separately from each other.

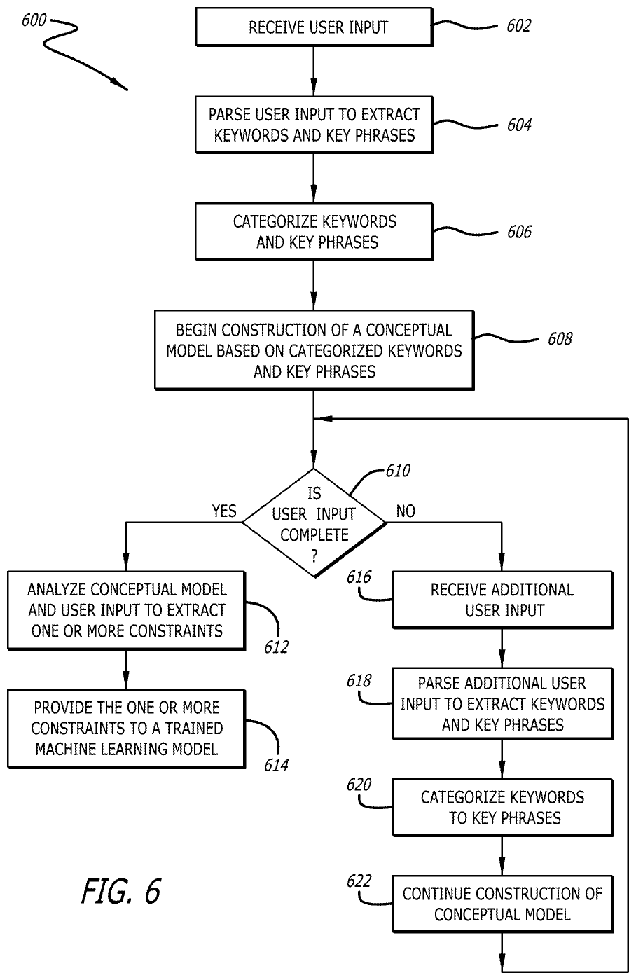

As an illustrative embodiment, FIG. 5 provides a sample graphical user interface illustrating the costs of a department within a corporation compared to revenue for the same department according to some embodiments. The graphical user interface 500 is illustrated as being rendered within a web browser and including a plurality of display components including a vertically plotted bar chart 502 and a plurality of information boxes 504-508. The bar chart 502 compares the department's costs with the department's revenue on a monthly basis while the information boxes 504-508 present data such as a listing of expenses per month (box 504), a listing of expenses per approving employee (box 506) and a listing of revenue streams per month (box 508). Dissecting the graphical user interface 500 provides an example of the knowledge required of the underlying entities, their corresponding attributes and the relationships between entities in order to generate the graphical user interface 500. For instance, the bar chart 502 requires at least the following entities: (1) a department, (2) a cost, and (3) an expense. Additionally, the cost and revenue are understood as attributes of the department while also being entities such that each of the cost entity and the expense entity has (i) a name, (ii) a timestamp, and (iii) an amount. Further review of the graphical user interface 500 reveals additional attributes of the department including employees, wherein an employee is itself an entity having attributes of (i) a name, and (ii) an employee identifier.

In addition, and possibly more importantly, an understanding of the information sought by the user from reviewing the graphical user interface 500 is required in order to generate a display of information appropriate for the user. For instance, if the user is attempting to extract how revenue fluctuates on a yearly basis over the past ten years, the graphical user interface 500 is completely useless to the user. Therefore, the authoring system discussed below extracts an understanding of the user's needs and desires in a user interface as well as the entities, corresponding attributes and the relationships between entities in order to generate in order to automatically generate a plurality of proposed UI designs based on user input.

1. First Exemplary Conceptual Model Generation Methodology

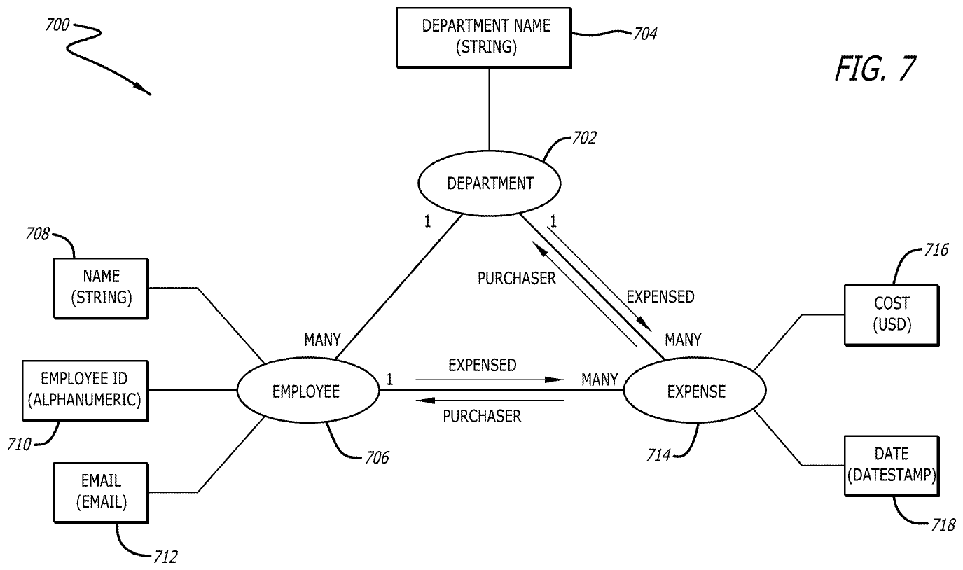

In a first embodiment, the authoring system generates a conceptual model based on user input and determines a set of constraints prior to providing the set of constraints and any additional information to the ML model. Referring to FIG. 6, a flowchart illustrating a first exemplary method for generating a conceptual model by the authoring system 400 is shown in accordance with some embodiments. Each block illustrated in FIG. 6 represents an operation performed in the method 600 of generating a conceptual model by the authoring system (e.g., as illustrated in FIG. 4). Prior to the start of the method 600, it is assumed that a ML model for generating one or more proposed UI designs has been trained by a ML model training logic of the authoring system. The method 600 begins when the authoring system receives user input (block 602). The user input may in received in one or more forms such as free form text in response to a prompted question, as free form text that includes words or terms suggested by the authoring system, or a selection of an answer from a predetermined answer set. The user input may comprise answers to a plurality of questions, such that the questions may be predetermined (e.g., follow a predetermined question flow wherein user input of an answer determines the path of the question flow). The user input is parsed to extract keywords and key phrases (block 604). The keywords and key phrases may include nouns and verbs, for example. In one example, the logic of the authoring system corresponds each answer from each predetermined answer set to a noun, a verb, or a combination thereof. With respect to free form text (with or without suggested words or phrases), logic of the authoring system may utilize Natural Language Processing (NLP) techniques to determine the keywords or key phrases. For instance, the logic of the authoring system may employ Named Entity Resolution (NER).

Following extraction of the keywords and key phrases, the authoring system categorizes the keywords and key phrases (block 606). The categorization may include determining whether each keyword, key phrase represents an entity, an attribute or a relationship. The relationship may be between two entities or between an entity and an attribute (e.g., Attribute A is an attribute of Entity B). The categorization of the keywords or key phrases may combined with the operations of block 604. For example, the NLP (e.g., using NER) may determine whether a word is a noun or verb and subsequently categorize the word as an entity, attribute, action or relationship. Alternatively, each answer within each predetermined answer set corresponds to specific entities, attributes, actions and/or relationships known to the logic of the authoring system (e.g., definitions of entities, attributes, actions and/or relationships may be stored in a data store of the authoring system or accessible by the authoring system).

The authoring system then begins constructions on a conceptual model (block 608). As discussed above, the conceptual model may be a heterogeneous information network (HIN) represented as a nodal diagram that may include entities of multiple data types. The authoring system then determines whether the receipt of user input is complete (block 610).

When the receipt of user input is complete, the authoring system analyzes the conceptual model and the user input to extract one or more constraints (block 612). In some embodiments, the conceptual model is provided to the ML model, which performs operations including machine learning algorithms such as supervised learning algorithms, unsupervised learning algorithms and/or semi-supervised learning algorithms. More particularly, these algorithms may include logistic regression, back propagation neural networks, the Apriori algorithm, the Eclat algorithm, and/or the K-Means algorithm. However, it should be understood that additional machine learning algorithms may be utilized such as any regression algorithms, rule minoring algorithms, instance-based algorithms, regularization algorithms, decision tree algorithms, Bayesian algorithms, clustering algorithms, association rule learning algorithms, artificial neural network algorithms, deep learning algorithms, dimensionality reduction algorithms, and/or ensemble algorithms. In addition, one or more constraints may be retrieved from a data store of predetermined constraints based on the user input. In one embodiment, the authoring system traverses the conceptual model to determine common attribute data types among differing entity types, such that a common attribute data type among a plurality of entity types may serve as a basis for a constraint. Alternatively, in some embodiments, the constraints are extracted from the user input directly, e.g., a question presented to the user may explicitly ask about a particular feature such as the inclusion of filters, the number of filters desired, particular information the user wants displayed, the ability for a user to select items displayed (e.g., employee names displayed within a graph or chart) and obtain additional information thereon. The one or more constraints are than provided to a trained ML model (block 614), which processes at least the one or more constraints to determine one or more proposed UI designs.

When the receipt of user input is incomplete, the authoring system receives additional user input (block 616). The additional user input is parsed to extract keywords and key phrases (block 618). Following extraction of the keywords and key phrases, the authoring system categorizes the keywords and key phrases as discussed above with respect to block 606 (block 620). The authoring system continues construction of the conceptual model based on the categorized keywords and key phrases (block 622). The method returns to block 610 where the authoring system determines whether receipt of user input is complete. The method 600 then continues as discussed above.

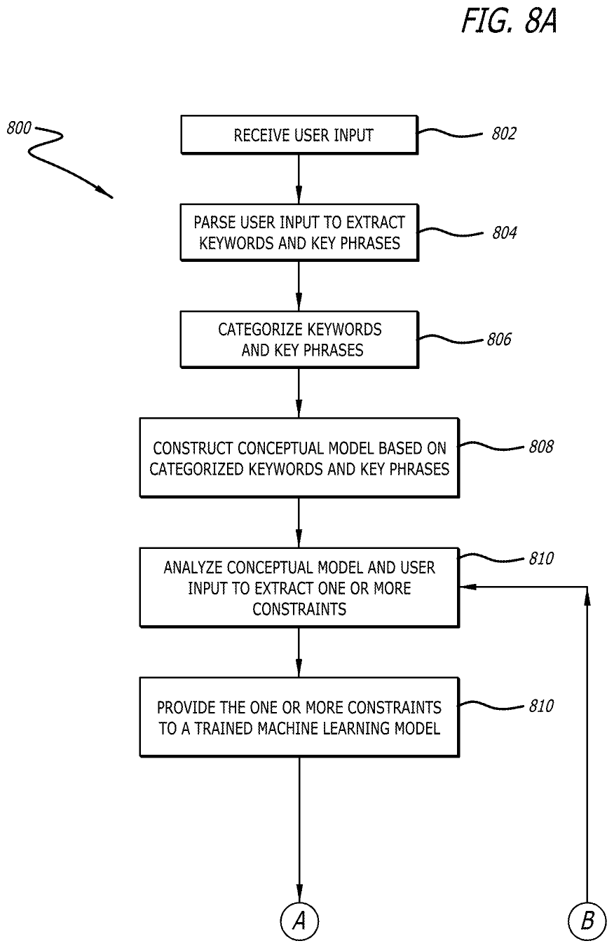

Referring to FIG. 7, an illustration of a sample detailed conceptual model is shown in accordance with some embodiments. The conceptual model 700 illustrates a sample detailed conceptual model in the form of a heterogeneous information network (HIN). The HIN is illustrated as a nodal diagram, wherein the nodes may differ in data type (i.e., are not homogeneous in type). Specifically, FIG. 7 is illustrating an exemplary conceptual model of a corporate department. Such a conceptual model may be automatically built by the authoring system 400 upon receipt of user input.

As shown, the node 702 may represent a first entity (e.g., a department within a corporation) and the node 704 represents an attribute of the department being a department name. The edge connecting the nodes 702 and 704 symbolize the node 704 (department name) is an attribute of the node 702 (department). Specifically, the edge symbolizes that the department 702 has an attribute being department name 704, and that the department name 704 is an attribute of the department 702. Similarly, the node 706 represents another entity being an employee. As the department entity 702 may have multiple employees, the edge connecting the department entity 702 to the employee entity 706 indicates a 1-to-many relationship. The employee entity 706 is shown to have attributes including a name 708, an employee identifier 710 and an email address 712.

Also shown in FIG. 7 is an entity 714 representing an expense. The expense entity 714 is connected to the department entity 702 with a 1-to-many relationship (one department to many expenses). The expense entity 714 is also connected to the employee entity 706 with a 1-to-many relationship (one employee to many expenses).

2. Second Exemplary Conceptual Model Generation Methodology

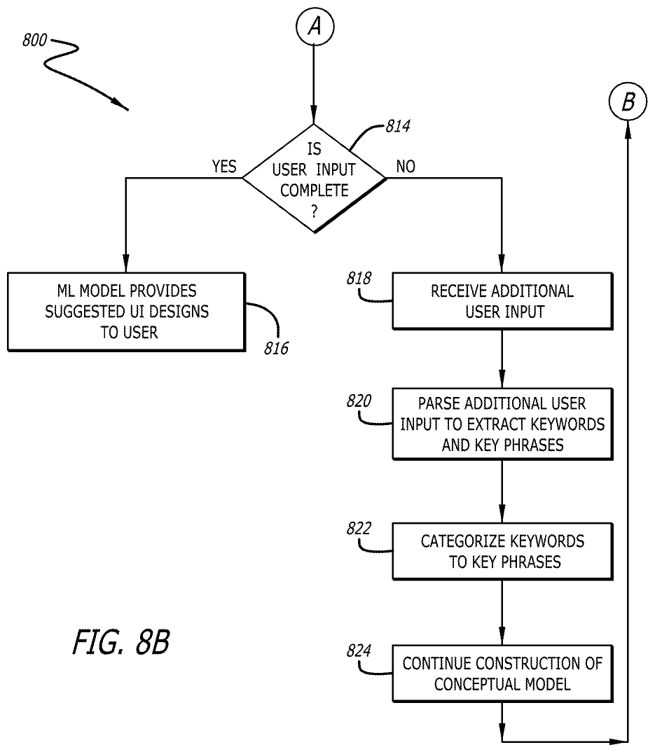

In a second embodiment, the authoring system generates a portion of a conceptual model based on user input, determines a set of constraints that are provided to the ML model. The ML model generates at least a portion of one or more UI designs (“proposed UI designs”) based on the constraints and other input (e.g., the portion of the conceptual model). Further, the authoring system receives additional user input that is added to the portion of the conceptual model, additional (or alternative constraints are determined) and the initial constraints along with the additional constraints are provided to the ML model, which generates updated proposed UI designs. Referring to FIGS. 8A-8B, a flowchart illustrating a second exemplary method for generating a conceptual model by the authoring system 400 is shown in accordance with some embodiments. Each block illustrated in FIGS. 8A-8B represents an operation performed in the method 800 of generating a conceptual model by the authoring system (e.g., as illustrated in FIG. 4). Prior to the start of the method 800, it is assumed that a ML model for generating one or more proposed UI designs has been trained by a ML model training logic of the authoring system. The method 800 begins when the authoring system receives user input (block 802). The user input may in received in one or more forms as discussed above with respect to FIG. 6. The user input is parsed to extract keywords and key phrases as discussed above with respect to FIG. 6 (block 804).

Following extraction of the keywords and key phrases, the authoring system categorizes the keywords and key phrases (block 806). As discussed above, the categorization may include determining whether each keyword, key phrase represents an entity, an attribute or a relationship. The categorization of the keywords or key phrases may combined with the operations of block 804 in a similar manner as discussed with respect to FIG. 6.

The authoring system then begins constructions on a conceptual model (block 808). As discussed above, the conceptual model may be a heterogeneous information network (HIN) represented as a nodal diagram that may include entities of multiple data types. The authoring system then analyzes the conceptual model and the user input to determine one or more initial constraints (block 810). Some constraints may be predefined and retrieved from a data store accessible to the authoring system, wherein selection of a predefined constraint may be based on the user input and/or the conceptual model. However, as discussed above, in some embodiments, the ML model determines one or more constraints as an alternative, or in addition to, constraints determined by the constraint determination logic 408 of the authoring system 400 and/or predefined constraints. For instance, as discussed above, the ML model may perform operations including rule learning algorithms (such as a rule mining algorithm). The one or more constraints are than provided to a trained ML model (block 812), which processes at least the one or more constraints to determine proposed UI designs.

Referring now to FIG. 8B, the authoring system then determines whether the receipt of user input is complete (block 814). When the receipt of user input is complete, the ML model provides the proposed UI designs to the user (block 816).

When the receipt of user input is incomplete, the authoring system receives additional user input (block 818). The additional user input is parsed to extract keywords and key phrases (block 820). Following extraction of the keywords and key phrases, the authoring system categorizes the keywords and key phrases as discussed above with respect to block 806 (block 820). The authoring system continues construction of the conceptual model based on the categorized keywords and key phrases (block 824). The method returns to block 810 where the authoring system analyzes the conceptual model and the user input to determine one or more additional constraints. The method 800 then continues as discussed above.

Although the above disclosure mostly provides examples of proposed UI designs, the authoring system may equally automates the process for developing proposed UX designs (in demo format and/or in production-ready code). For instance, the authoring system, and specifically the constraint determination logic and the trained machine-learning models may also utilize various UX factors in determining constraints and in development of the proposed UI/UX designs (wherein the term “proposed UI/UX designs” refers to the inclusion of one or more UX factors in the generation process). For instance, the constraint determination logic may also consider one or more of the following UX factors: usefulness, usability, findability, credibility, desirability, accessibility and valuableness. Reference to certain UX factors may be included within questions prompted to the user as discussed above. Additionally, the UX factors may be included within predefined constraints (e.g., predetermined rules that are based on best practices and experiential knowledge such as real-world data obtained through data collection from previous UI/UX designs including user time spent on a UI screen, click rate, etc.). It should be noted that the use of real-world data may be utilized equally for UI constraints and by any trained ML model.

While this invention has been described in connection with what is presently considered to be practical embodiments, embodiments are not limited to the disclosed embodiments, but, on the contrary, may include various modifications and equivalent arrangements included within the spirit and scope of the appended claims. The order of operations described in a process is illustrative and some operations may be re-ordered. Further, two or more embodiments may be combined.

What is claimed is:

1. A computer-implemented method, the method comprising:
receiving user input;
constructing a conceptual model based on at least a portion of the user input;
determining one or more constraints based on one or more of the user input or the conceptual model; and
generating at least a first proposed user interface (UI) design using machine learning techniques, wherein the one or more constraints are provided as input to a trained machine learning model, wherein processing by the trained machine learning model generates at least the first proposed UI design.

2. The computer-implemented method of claim 1, further comprising:
parsing the user input to extract keywords and the key phrases; and
categorizing at least a portion of the keywords and the key phrases,
wherein constructing the conceptual model is based on at least a portion of the categorized keywords and the categorized key phrases.

3. The computer-implemented method of claim 1, further comprising:
causing rendering of the first UI design on a display screen thereby enabling a user to visualize the first UI design.

4. The computer-implemented method of claim 1, further comprising:
receiving additional user input;
supplementing the conceptual model based on at least the portion of the additional user input;
determining one or more additional constraints based on one or more of the additional user input or the supplemented conceptual model; and
providing the one or more additional constraints to the trained machine learning model.

5. The computer-implemented method of claim 4, further comprising:
parsing the additional user input to extract additional keywords and the additional key phrases; and
categorizing at least a portion of the additional keywords and the additional key phrases,
wherein supplementing the conceptual model is based on at least the portion of the categorized keywords and the categorized key phrases.

6. The computer-implemented method of claim 4, further comprising:
generating at least a second proposed user interface (UI) design using the machine learning techniques, wherein the additional one or more constraints are provided as second input to the trained machine learning model, wherein processing by the trained machine learning model generates at least the second proposed UI design.

7. The computer-implemented method of claim 1, wherein the conceptual model is a heterogeneous information network (HIN).

8. The computer-implemented method of claim 7, wherein the HIN includes a plurality of nodes and at least one edge, wherein each of the plurality of nodes represents an entity included within the user input and each edge represents a relationship between two entities.

9. A system comprising:
a memory to store executable instructions; and
a processing device coupled with the memory, wherein the instructions, when executed by the processing device, cause operations including:
receiving user input;
constructing a conceptual model based on at least a portion of the user input;
determining one or more constraints based on one or more of the user input or the conceptual model; and
generating at least a first proposed user interface (UI) design using machine learning techniques, wherein the one or more constraints are provided as input to a trained machine learning model, wherein processing by the trained machine learning model generates at least the first proposed UI design.

10. The system of claim 9, further comprising:
parsing the user input to extract keywords and the key phrases; and
categorizing at least a portion of the keywords and the key phrases,
wherein constructing the conceptual model is based on at least a portion of the categorized keywords and the categorized key phrases.

11. The system of claim 9, further comprising:
causing rendering of the first UI design on a display screen thereby enabling a user to visualize the first UI design.

12. The system of claim 9, further comprising:
receiving additional user input;
supplementing the conceptual model based on at least the additional user input;
determining one or more additional constraints based on one or more of the additional user input or the supplemented conceptual model; and
providing the one or more additional constraints to the trained machine learning model.

13. The system of claim 12, further comprising:
parsing the additional user input to extract additional keywords and the additional key phrases; and
categorizing at least a portion of the additional keywords and the additional key phrases, wherein supplementing the conceptual model is based on at least the portion of the categorized keywords and the categorized key phrases.

14. The system of claim 12, further comprising:
generating at least a second proposed user interface (UI) design using the machine learning techniques, wherein the additional one or more constraints are provided as second input to the trained machine learning model, wherein processing by the trained machine learning model generates at least the second proposed UI design.

15. The system of claim 9, wherein the conceptual model is a heterogeneous information network (HIN).

16. The system of claim 15, wherein the HIN includes a plurality of nodes and at least one edge, wherein each of the plurality of nodes represents an entity included within the user input and each edge represents a relationship between two entities.

17. A non-transitory computer readable storage medium having stored thereon instructions, the instructions being executable by one or more processors to perform operations comprising:
receiving user input;
constructing a conceptual model based on at least a portion of the user input;
determining one or more constraints based on one or more of the user input or the conceptual model; and
generating at least a first proposed user interface (UI) design using machine learning techniques, wherein the one or more constraints are provided as input to a trained machine learning model, wherein processing by the trained machine learning model generates at least the first proposed UI design.

18. The non-transitory computer readable storage medium of claim 17, further comprising:
parsing the user input to extract keywords and the key phrases; and
categorizing at least a portion of the keywords and the key phrases,
wherein constructing the conceptual model is based on at least a portion of the categorized keywords and the categorized key phrases.

19. The non-transitory computer readable storage medium of claim 17, further comprising:
causing rendering of the first UI design on a display screen thereby enabling a user to visualize the first UI design.

20. The non-transitory computer readable storage medium of claim 17, wherein the conceptual model is a heterogeneous information network (HIN) that includes (i) a plurality of nodes, (ii) at least one edge, and (iii) one or more attributes of one or more entities, wherein each of the plurality of nodes represents an entity included within the user input and each edge represents a relationship between two entities.
